(19) United States
(12) Patent Application Publication
(10) Pub. No.: US 2020/0023335 A1
(43) Pub. Date: Jan. 23, 2020

(54) ADSORBATES AND METHODS FOR SEPARATION AND RECOVERY OF PHOSPHATE, NITRATES, AND AMMONIA FROM WATER

(71) Applicant: Water Warriors, Inc., Cincinnati, OH (US)

(72) Inventors: Rakesh Govind, Cincinnati, OH (US); Mallikarjuna Nadagouda, Mason, OH (US)

(21) Appl. No.: 16/514,990

(22) Filed: Jul. 17, 2019

Related U.S. Application Data
(60) Provisional application No. 62/699,389, filed on Jul. 17, 2018.

(51) Int. Cl. B01J 20/04; B01J 20/02; B01J 20/30; B01J 20/28; C02F 1/28

(52) U.S. Cl. CPC B01J 20/043; B01J 20/0207; B01J 20/0277; B01J 20/0229; B01J 20/3042; B01J 20/3064; C02F 2101/105; B01J 20/3007; B01J 20/3078; B01J 20/28045; C02F 1/288; C02F 1/281; C02F 1/286; B01J 20/3021

(57) ABSTRACT

Water insoluble carbonates are utilized as adsorbents to remove phosphates from water flowing through an iron impregnated or coated foam. The iron impregnated or coated foam acts to improve the removal of phosphates as well as to remove nitrates and ammonia. A powdered carbonates/binder mixture, i.e. MgCO₃ and/or La₂(CO₃)₃ mixed with cellulose, is formed into pellets then calcined. Aqueous phosphates adsorb onto the surface area of the pellet for eventual removal. Calcining the pellets removes the cellulose binder and opens the interior of the pellet up to provide additional surface area for adsorption. These pellets are placed within a porous bag and placed with water, preferably within a flow of water.

### CROSS REFERENCE TO RELATED APPLICATIONS

This applications claims priority from U.S. Provisional Patent Application 62/354,744 filed on Jul. 17, 2019.

### FIELD OF THE INVENTION

Aspects of the present invention generally relate to methods for separating and recovering phosphates from water.

### BACKGROUND OF THE INVENTION

As the limiting nutrient in most waterways, increased phosphate (PO₄³⁻) concentrations can promote accelerated eutrophication, which has a range of environmental and economic impacts. Eutrophication leads to increased water treatment costs, decreased recreational value; but notably, the proliferation of algal blooms. Some of these blooms produce cyanotoxins like microcystins and cylindrospermopsin which can be detrimental to both human and aquatic health. Though chemical precipitation and biological treatments are commonly used methods for the remediation of PO₄³⁻, problems including costs, sludge production and stability/reliability issues have led to the research of alternative methods for the removal of PO₄³⁻ from waterways.

One process gaining considerable attention is adsorption. Adsorption is a surface-based phenomena resulting in the adhesion of an adsorbate on the surface of an adsorbent through covalent bonding and electrostatic interactions. Unlike chemical precipitation and biological removal processes, adsorption is unique in that it can remove contaminants over a wide pH range and at low concentrations. A wide variety of materials have been investigated for the adsorption of phosphate including metal oxides, waste materials, zeolites, and polymers. Lesser-studied materials for phosphate sorption are carbonates. Previous studies explored the use of calcium carbonates (CaCO₃) as phosphate binders to decrease phosphate concentrations in aquatic environments. Though phosphate binders are common medicinal compounds used to control blood phosphate levels in patients with hypertension or renal failure/insufficiency, their use as phosphate sorbents from waterways is gaining more attention.

### SUMMARY

Water insoluble carbonates are utilized as adsorbents to remove phosphates from water. A powdered carbonates/binder mixture, i.e. MgCO₃ and/or La₂(CO₃)₃ mixed with cellulose, are formed into pellets then calcined. Aqueous phosphates adsorb onto the surface area of the pellet for eventual removal. Calcining the pellets removes the cellulose binder and opens the interior of the pellet up to provide additional surface area for adsorption. These pellets are placed within a porous bag and placed with water, preferably within a flow of water. These porous bags of pelletized carbonates may also be placed within an open cell foam to filter common debris (e.g. leaves, wood and insects) that could potentially interfere with the porosity of the pellet bag. Optionally, the open cell foam may be impregnated or coated with iron to provide additional phosphate, nitrate, and ammonia removal efficacy.

### BRIEF DESCRIPTION OF THE FIGURES

FIG. 1 discloses SEM images of CaCO₃ (a) before and (b) after PO₄³⁻ adsorption, LaCO₃ (c) before and (d) after PO₄³⁻ adsorption, and MgCO₃ (e) before and (f) after PO₄³⁻ adsorption.

FIG. 2 discloses XRD patterns of carbonate pellets: (a) MgCO₃, (b) La₂(CO₃)₃, and (c) CaCO₃.

FIG. 3 discloses HR-TEM images of MgCO₃ pellets before (a) and after (b) PO₄³⁻ adsorption, La₂(CO₃)₃ pellets before (c) and after (d) PO₄³⁻ adsorption, and CaCO₃ pellets before (e) and after (f) PO₄³⁻ adsorption.

FIG. 4 discloses linearized Langmuir Isotherms for carbonates of interest in the present application.

FIG. 5 discloses linearized Linearized Freundlich Isotherms for carbonates of interest in the present application.

FIG. 6 discloses results for a column experiment for LaCO₃, CaCO₃, and MgCO₃-based adsorbents.

FIG. 7 discloses combined Langmuir and Freundlich Isotherms for LaCO₃ and CaCO₃.

FIG. 8 discloses Iron-impregnated into PU foam with increasing initial ferrous chloride concentrations in the presence of different oxidants.

FIG. 9 discloses Phosphate adsorption isotherms on various PU foam samples. The inset is for low concentration data points.

FIG. 10 is a porous pelletized carbonate adsorbant.

FIG. 11 is cross section plan view of the foam filter of the present application containing a carbonate adsorbant pellet housing.

### DETAILED DESCRIPTION OF THE INVENTION

Solid adsorbent structures comprised of carbonates, either MgCO₃ or La₂(CO₃)₃ or a mixture of both, are arranged within a porous housing and placed in water contaminated with phosphates. Ideally the structures are themselves porous so as to increase each structure's available surface area. In one embodiment, the structure is a substantially cylindrical pellet although other geometries are also useful.

The adsorbent structures are formed by blending a sold carbonate with a binder material, e.g. cellulose, into a slurry pre-mix. The mass % of cellulose as binder in the slurry pre-mix is no more than 50%, preferably less than 33%, and most preferably approximately 10%. The binder content is minimized so as to minimize the cost of the slurry premix and to ensure that the structural integrity of the pellet is not compromised by the removal of the binder. If too much of the slurry pre-mix is binder then it will form too much of the pellet and the framework of the structure will be weakened or collapse as the binder is removed.

The slurry pre-mix is diluted in deionized water and mixed to form a slurry. The slurry is then dried and subsequently ground into a powder. The powder is then pressed into a pellet form. In an embodiment, cylindrical pellets are formed having a diameter of approximately 5 mm and a depth of approximately 4 mm.

The pellets are then calcined to remove all or substantially all of the binder content. The temperature and length of time necessary for calcining vary by binder material. Cellulose, for example, can be burned off at temperatures at or above 200° C., more preferably at temperatures at or above 250° C., and most preferably at a temperature of approximately 300° C. Calcining times also vary by binder material. Cellulose, for example, should be calcined for 1 to 2 hours at the previously suggested temperatures. In an embodiment, the pellets are calcined at a temperature of 300° C. for 1 hour to remove substantially all of the binder. The calcined pellets are porous due to the removal of binder material from within the pellet. Calcining increases the available surface area for the adsorption of phosphates.

In an embodiment, the calcined pellets are housed within a porous housing, e.g. netting or a polypropylene bag, and placed in water containing phosphates for removal. Ideally the water will be moving across and through the pellets to improve adsorption efficacy, therefore agitation of the water or placing it within a flow of water facilitates phosphate removal.

In a further embodiment, the pellet housing is placed within an open cell foam filter to protect the pellets and ensure the free flow of water across and through the pellets by inhibiting debris from blanketing the pellet housing.

The use of water-insoluble carbonates for phosphate removal from water bodies and treated effluents from existing wastewater plants, can be exploited to remove phosphate in both uncontrolled storm water run-off and for end-of-pipe treatment to reduce phosphate concentration. This can be achieved by pelletizing the water insoluble carbonates, which would allow water to flow both through and between a packed bed of these pellets. The goal of using pellets is to reduce the pressure-drop for water flow while contacting the reactive carbonates with a high interfacial area, thereby increasing the efficiency of the phosphate removal and increasing its rate of reaction between the solid particle of the water-insoluble carbonate and phosphate present in the water.

The formation of high surface area pellets, diameter 1-3 mm, length 2-4 mm, using either a single or multiple water insoluble carbonates was accomplished using cellulose to bind the particles of the carbonates together, when compressed under high pressure. To achieve high surface area of the pellets which would require a flow-through capability in each pellet, the pellets were calcined in air at 200-300 deg C. to allow the cellulose to become carbonized to carbon dioxide forming a network of passages through the pellet, while keeping the pellet particles of the carbonate(s) together. The calcination time varies between 1-2 hours, and after 2 hours, enough cellulose has been converted to carbon dioxide to form a pellet with porosity exceeding 70-80%. After 80% porosity, the pellet will begin to disintegrate into smaller particles.

The pellets can be packed in a polypropylene bag, 3-4 inches in diameter and about 4 ft in length to form a boom, which when put into water, will begin to absorb and complex phosphates in the water. The rate of phosphate removal is dependent on the phosphate concentration and the rate of water flow through the porous polypropylene bag. These bags are then inserted into a concentric open cell foam structure.

Sample Characterization: The Brunauer, Emmett, and Teller (BET) surface area of the adsorbents was determined using a Tristar 3000 porosimeter analyzer (Micromeritics). Prior to characterization, the samples were first outgassed by purging with nitrogen gas at 150° C. for 2 hr using a Micromeritics FlowPrep 060. The surface morphology of the various materials was characterized using an environmental scanning electron microscope (ESEM, model Philips XL 30 ESEM-FEG). Elemental analysis of the samples was performed using Energy-dispersive X-ray spectrophotometer (EDS) installed in the ESEM. The crystal structure of the adsorbents was determined by X-ray diffraction (XRD) analysis using a Panalytical (Expert) 2-theta diffractometer (Panalytical, Almelo, Netherlands) at a wavelength of 1.54 μm and at 2-theta range 2-90° under CuK_{α} radiation. To gain further insights on the physical properties of the synthesized materials, high resolution-transmission electron microscopy (HR-TEM, model JEM-2010F, obtained from JEOL) was used with a field gun emission at 200 kV. Before analysis, the materials were dispersed by ultrasonication (2510R-DH, Bransonic) in 99.8% pure isopropyl alcohol (Pharmco-AAPER) for 20 min. Then, a single drop of the supernatant was fixed on a carbon-coated copper grid (LC325-Cu, EMS) and dried at room temperature prior to imaging. The obtained images were analyzed using ImageJ, an image processing software (National Institutes of Health, Maryland, USA).

Adsorption Experiments: To evaluate the effectiveness of each adsorbent for the removal of phosphate, several adsorption experiments were conducted and their results compared. Variable dose isotherm experiments were conducted to determine equilibrium adsorption parameters.

Varying masses of adsorbent, ranging from 0.15-1.5 g, were placed in 125 mL Nalgene polypropylene bottles with 100 mL of the phosphate stock solution. The solution was prepared by dissolving sodium phosphate monohydrate in deionized water (2 mM) with 15 mM MOPS buffer to maintain a constant pH (pH 7). The bottles were placed on a G10 Gyrotary shaker (New Brunswick Scientific Co. Inc., USA) at 150 rpm for 2 weeks to ensure equilibrium was reached. After adsorbent saturation, samples were filtered using a 0.45 μm polypropylene syringe filter and analyzed for phosphate concentration remaining in solution.

Column tests were conducted in 80 cm height and 1.9 cm diameter Harvel plastic columns. Ten grams of adsorbent media was placed in the columns with sand and gravel above and below, as well as a stainless steel sieve at the bottom end of the column to prevent washout. Using a Thermo Scientific™ FH100M Series Peristaltic pump, the phosphate solution (at an initial phosphate concentration of 215 mg L⁻¹), was passed through the column at a rate of 2 mL min⁻¹ at room temperature. Similar to the isotherm experiment, solution pH was adjusted initially and buffered to remain constant. The column effluent samples were collected, filtered using a 0.45 μm polypropylene syringe filter, and analyzed for phosphate concentration at various time periods. All isotherm and column experiments were conducted once and sample measurements were analyzed in triplicate and averaged.

The phosphate concentration in all experiments was analyzed by a colorimetric measurement technique in which ammonium molybdate and potassium antimonyl tartrate react in an acidic solution with orthophosphate to form phosphomopydbic acid which can be reduced by ascorbic acid to form an intense blue color. The absorbance due to the blue complex was monitored at 880 nm using a UV-Vis spectrophotometry (HACH model number DR 2700). This is based off the US EPA Method 365.1 for the determination of dissolved orthophosphate [34].

Sample Characterization: The BET surface area for each adsorbent was measured prior to and after phosphate adsorption, as illustrated in Table 1. The adsorbent with the highest BET surface area was the MgCO₃ pellet, which had a surface area of roughly 26 m² g⁻¹ prior to phosphate adsorption, while the other adsorbents had much lower surface areas of about 2 m² g⁻¹. Since adsorption is a surface-based process, higher surface areas should correlate to an increased adsorption capacity as there are an increased number of sites for the phosphate ions to adhere to the sorbent surface. Upon comparison of BET surface areas prior to and after phosphate adsorption, the used samples were found to have higher surface areas. This increase in surface area after adsorption indicates that the phosphate is sorbed onto the material surface, forming a surface complexation, thus resulting in an increased surface area when compared to the unused sorbents. Similar results were found in our previous study.

TABLE 1
Adsorbent Surface Area Before and After PO₄³⁻ Adsorption

| | Before PO₄³⁻ | After PO₄³⁻ |
|---|---|---|
| Adsorbent | Adsorption (m²/g) | Adsorption (m²/g) |
| MgCO₃ | 25.9941 ± 0.1409 | 28.0135 ± 0.1840 |
| CaCO₃ | 2.1772 ± 0.0264 | 2.3375 ± 0.0424 |
| LaCO₃ | 1.8120 ± 0.0218 | 6.9839 ± 0.1074 |

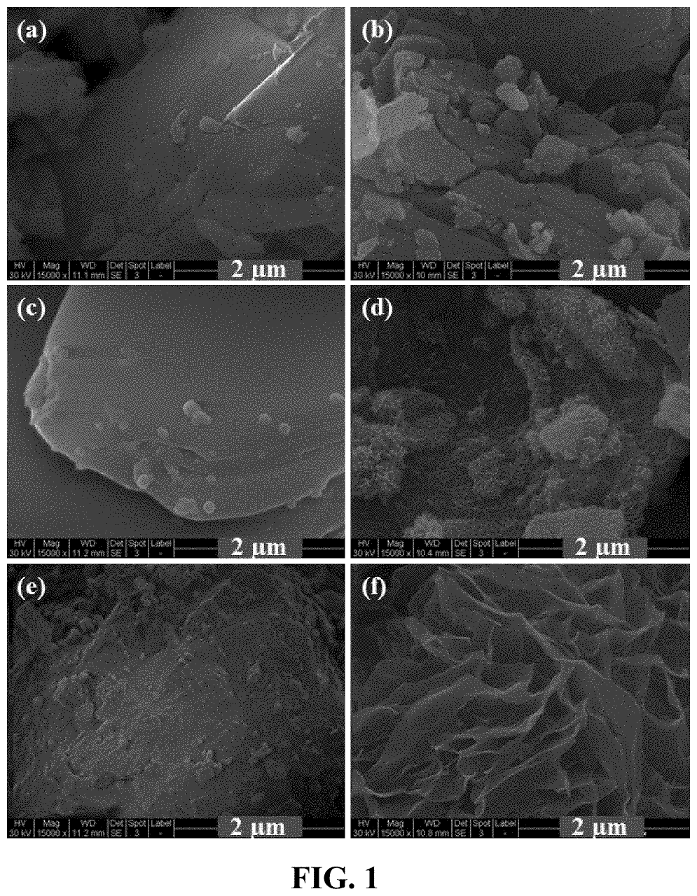

SEM was conducted to evaluate the surface morphology of the different adsorbents before and after PO₄³⁻ adsorption as illustrated in FIG. 1. The different adsorbents yielded quite different surface morphologies, which may play a significant role in overall phosphate adsorption. For the CaCO₃ sample, seen in FIGS. 1 (a) and (b), the surface structure appears to form as a bulky, irregular crystal with particles ranging from nano- to micron-sized. The La₂(CO₃)₃ sample, illustrated in FIG. 1 (d), revealed the formation of aggregates ranging from 0.5 to 2.0 μm after PO₄³⁻ adsorption compared to the pellet before adsorption as seen in FIG. 1 (c). FIG. 1 (f) shows SEM images for the MgCO₃ adsorbent. This material had a sheet like structure, similar in appearance to the mineral selenite rose, with amorphous “sheets” averaging 2 μm in length.

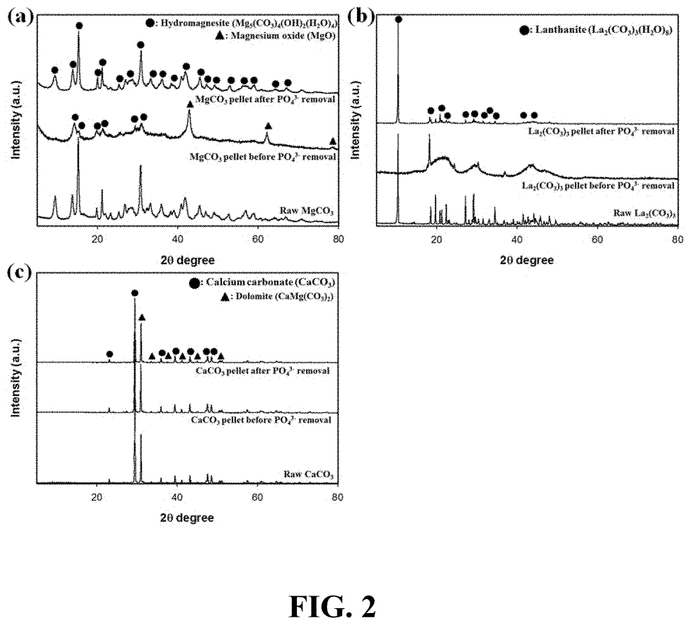

FIG. 2 shows XRD patterns of MgCO₃, CaCO₃, and La₂(CO₃)₃ samples. The peaks of XRD spectra were identified using JADE software (MDI, Inc., Livermore, Calif.) with JCPDS 04-013-7631 for hydromagnesite (Mg₅(CO₃)₄(OH)₂(H₂O)₄), 04-009-5447 for magnesium oxide (MgO), 04-010-3609 for lanthanite (La₂(CO₃)₃(H₂O)₈), 01-080-9776 for calcium carbonate (CaCO₃) and 00-036-0426 for dolomite (CaMg(CO₃)₂). As seen in FIG. 2 (a), raw MgCO₃ powder was already converted into hydromagnesite due to humidity in the air. It was partially converted into MgO during the heat treatment with cellulose for the pellet preparation. MgO was converted into hydromagnesite again during PO₄³⁻ removal processes. Unfortunately, the formation of newberyite (MgHPO₄(H₂O)₃) was not observed, which may be due to concentrations below the detection limit. This may indicate that PO₄³⁻ adsorption occurs on the surface of pellets since the presence of phosphorus was detected by EDS analysis (see Figure S1). For lanthanum pellets, lanthanite (La₂(CO₃)₃(H₂O)₈) was observed in raw La₂(CO₃)₃ powders due to humidity in the air. However, lanthanite peaks were not detected in the sample calcined with cellulose but lanthanum still remained as seen in FIG. 51. Again, lanthanite formed after PO₄³⁻ adsorption. A similar phenomenon was observed in the MgCO₃ samples where no peaks corresponding to phosphorus containing lanthanum were detected. This may also be due to the surface-limited reaction for PO₄³⁻ adsorption. In this case, although the peak corresponding to phosphorus was detected in EDS analysis, the concentration of phosphorus could not be determined because of lower concentration of phosphorus on the surface of La₂(CO₃)₃ pellets as well as a masking effect due to gold coating for SEM analysis (see FIG. S1). For CaCO₃ pellets, two compounds, CaCO₃ and CaMg(CO₃)₂, were detected and these phases did not change during the entire preparation and treatment processes. This indicates CaCO₃ samples are very stable in water. Interestingly, no phosphorus containing forms in all three pellets were detected with XRD analysis. As discussed before, this is likely due to the surface-limited reaction for PO₄³⁻ adsorption and EDS analysis supported the findings.

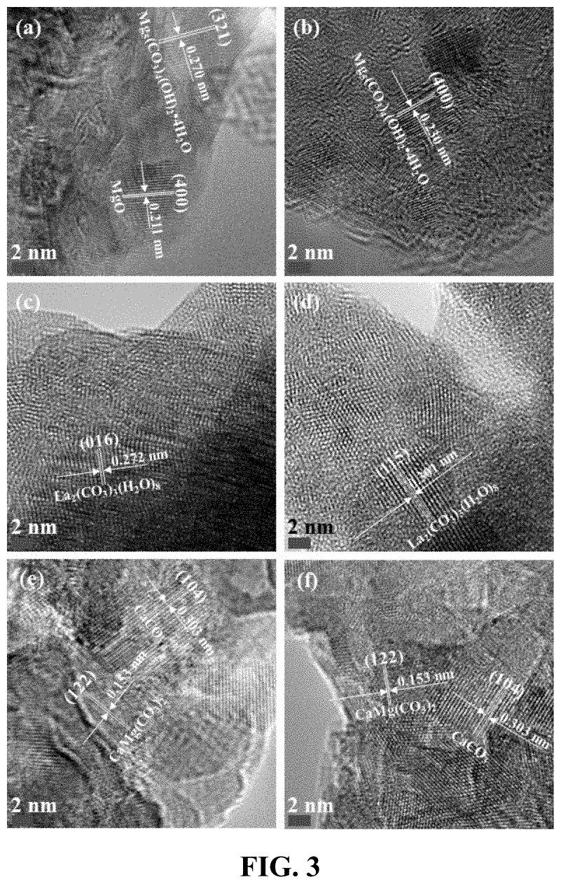

FIG. 3 shows HR-TEM images of each sample. As seen in FIG. 3 (a), the measured lattice spacing in the MgCO₃ pellets before PO₄³⁻ adsorption were 0.270 and 0.211 nm, corresponding to (321) plane of Mg₅(CO₃)₄(OH)₂(H₂O)₄ and (400) plane of MgO, respectively. After PO₄³⁻ adsorption, the lattice spacing of 0.230 nm, which corresponds to (400) plane of Mg₅(CO₃)₄(OH)₂(H₂O)₄, was measured (see FIG. 3 (b)). These results were in good agreement with the results of XRD analysis showing the presence of both hydromagnesite and magnesium oxide in the pellet before adsorption process and MgO was converted into hydromagnesite after PO₄³⁻ adsorption. As seen in FIGS. 3 (c) and (d), the measured lattice spacing of 0.272 and 0.301 nm corresponding to (016) and (115) planes of La₂(CO₃)₃(H₂O)₈, respectively, indicated the presence of lanthanum carbonate in the pellets even though the XRD patterns were not clear after the pellet preparation using cellulose. For CaCO₃ pellets, lattice spacings of 0.303 and 0.153 nm were observed, which correspond to the (104) plane of CaCO₃ and (122) plane of CaMg(CO₃)₂, respectively. These results are also in good agreement with the XRD results. Unfortunately, no lattice spacing corresponding to phosphorus-containing compounds was observed in the analyzed area of each sample after PO₄³⁻ adsorption since a very limited area can be shown with HR-TEM analysis at very high magnification of 800,000.

Adsorption Results: The specific relationship between the equilibrium adsorbate concentration in solution and the amount adsorbed at the surface can be revealed by adsorption isotherms. The isotherm results for phosphate adsorption onto the La-, Ca-, and Mg—CO₃-based sorbents at a constant temperature of 21° C. were analyzed using the Langmuir and Freundlich isotherm models. The Langmuir adsorption equation is based on the assumptions that: (1) adsorption is limited to one monolayer, (2) all surface sites are equivalent (i.e. free of defects), and (3) adsorption to one site is independent of adjacent sites occupancy condition^{[36]}. The Langmuir isotherm^{[37]} is expressed as:

$${q}_{e} = \frac{{q}_{max} {K}_{L} {C}_{e}}{1 + {K}_{L} {C}_{e}}$$

where qₑ is the amount of adsorbate adsorbed per unit mass of adsorbent (mg/g), Cₑ is the amount of unadsorbed adsorbate concentration in solution at equilibrium (mg/L), qₘₐₓ is the maximum amount of adsorbate per unit mass of adsorbent to form a complete monolayer on the surface (mg/g), and K_{L} is a constant related to the affinity of the binding sites (L/mg). In its linear form, the Langmuir equation can be expressed as:

$$\frac{{C}_{e}}{{q}_{e}} = \frac{1}{{q}_{max}} {C}_{e} + \frac{1}{{K}_{L} {q}_{max}}$$

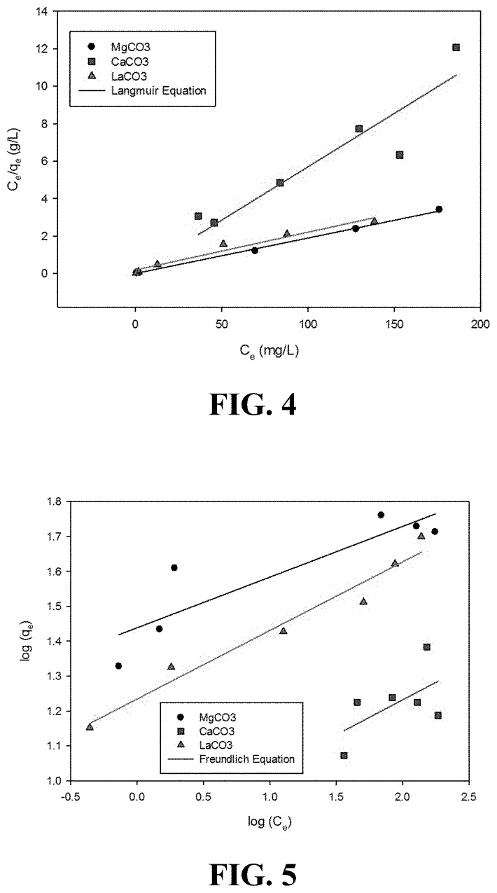

A linear plot of specific adsorption against equilibrium concentration ((Cₑ/qₑ) vs. Cₑ) as seen in FIG. 4 indicates that phosphate adsorption onto the La-, Ca-, and Mg—CO₃-based adsorbents obeys the Langmuir model. The Langmuir constants qₘₐₓ and K_{L}, determined from the slope and intercept of the plot, are presented in Table 2.

TABLE 2
Isotherm Parameters

| | Langmuir Isotherm | | | | Freundlich Isotherm | | |
|---|---|---|---|---|---|---|---|
| | Parameters | | | | Parameters | | |
| | qₘₐₓ | K_{L} | | | | K_{F} (mg/g) | |
| Adsorbent | (mg/g) | (L/mg) | R_{L} | R² | n | (L/mg)^{1/n} | R² |
| LaCO₃ | 49.5 | 0.108 | 0.0413 | 0.964 | 5.09 | 17.16 | 0.962 |
| CaCO₃ | 18.7 | 0.112 | 0.0398 | 0.855 | 5.00 | 6.78 | 0.338 |
| MgCO₃ | 52.6 | 12.67 | 0.0004 | 0.998 | 5.55 | 23.95 | 0.822 |

While the LaCO₃ and MgCO₃-based adsorbents had similar monolayer phosphate adsorption capacities (49.5 and 52.6 mg/g, respectively), the CaCO₃-based adsorbent had a much lower capacity for phosphate adsorption (18.7 mg/g). The dimensionless constant separation factor R_{L}^{[38]} can be used to express essential characteristics of the Langmuir isotherm according to the following equation:

$${R}_{L} = \frac{1}{1 + {K}_{L} {C}_{0}}$$

where C₀ is the initial adsorbate concentration (mg/L) and K_{L} is the Langmuir constant (L/mg). Values of R_{L} can indicate the favorability of adsorption; that is, for favorable adsorption, 0<R_{L}<1; for unfavorable adsorption, R_{L}>1; R_{L}=1 for linear sorption; and for irreversible adsorption, R_{L}=0^{[35]}. Values of R_{L}, documented in Table 2, were in the range of 0-1, suggesting favorable adsorption of phosphate onto the La-, Ca-, and Mg—CO₃-based adsorbents.

The Freundlich isotherm^{[39]}, applicable for non-ideal adsorption on heterogeneous surfaces with multi-layer sorption, is expressed as:

qₑ=K_{F}Cₑ^{1/n}

where K_{F} is the adsorption capacity of the adsorbent (mg/g (L/mg)^{1/n}) and n indicates sorption favorability, with values of n in the range 1<n<10 indicating favorable sorption. As values of n approach 1, the impact of surface heterogeneity can be assumed less significant and as n approaches 10, surface heterogeneity becomes more significant^{[40]}. Typically, adsorption capacity of an adsorbent increases as the values of K_{F} increase. The Freundlich constants K_{F} and n can be determined by the linearized form of the Freundlich equation:

$$log {q}_{e} = log {K}_{F} + \frac{1}{n} log {C}_{e}$$

The linear plot of the Freundlich isotherm for phosphate adsorption onto phosphate the La, Ca-, and Mg—CO₃-based adsorbents is shown in FIG. 5. The Freundlich constants were determined from the slope and intercept of the plot and are documented in Table 2.

Isotherm results best followed the Langmuir model, which assumes the formation of a monolayer of adsorbate on the adsorbent. According to the Langmuir isotherm, the Mg—CO₃-based adsorbent proved to have the highest adsorption capacity, followed by the La—CO₃-based adsorbent while the Ca—CO₃-based adsorbent was not as effective at removing phosphate. The increased phosphate removal for the MgCO₃ material is likely due to its increased BET surface area.

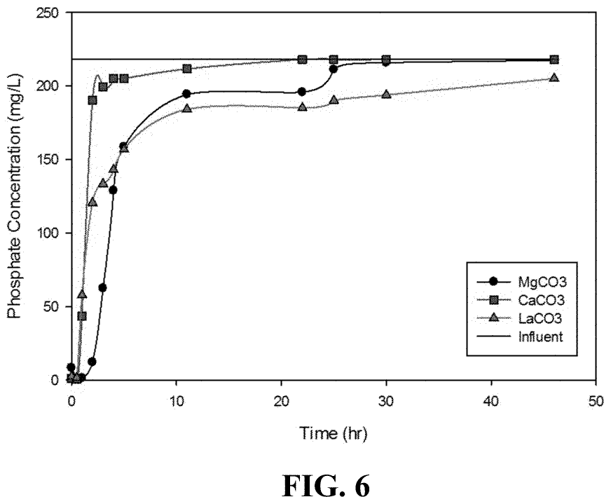

Column experiments were conducted to quantify the mechanisms of phosphate adsorption as would be seen in an industrial-scale fixed bed adsorber. The breakthrough curves were constructed by plotting the ratio of PO₄³⁻ concentration at time t to the initial influent concentration (C/C₀) versus time (t). FIG. 6 shows the typical “S” shape of the breakthrough curves indicating the effects of mass transfer parameters as well as internal resistance within the column. Phosphate adsorption was initially high, decreasing with time until fully saturated. Breakthrough for LaCO₃ and CaCO₃ occurred at 30 min while, for MgCO₃, the time to reach breakthrough was 1 hr. Yet, after 7 hr of operation, the CaCO₃ adsorbent was 95% saturated while LaCO₃ and MgCO₃ were only 73 and 74% saturated, respectively. Though the time to reach breakthrough was twice as long for the MgCO₃ sorbent compared to the LaCO₃ sorbent, the LaCO₃ sorbent proved to have the greatest phosphate column capacity as well as having a longer operation time to reach 95% saturation (36 hr compared to 30 hr), indicating that the LaCO₃ adsorbent was the best sorbent for phosphate adsorption in continuous column experiments.

The cumulative adsorption capacity of the columns for phosphate adsorption was determined and illustrated in Table 3. Cumulative column adsorption capacity for LaCO₃, CaCO₃, and MgCO₃ was 20.1, 13.0, and 17.8 mg/g, respectively. These results show that the phosphate adsorbent capacity of the adsorbents in columns were lower when compared to batch experiments. However, the adsorbent mass differed between experiments and this is the likely reason for differing values of adsorbent capacity. Also, batch experiments were conducted using 0.1 L of phosphate solution while the continuous column experiments passed around 5.0 L of phosphate solution through the sorbents.

TABLE 3
Comparison of Phosphate Capacity based
on Column and Batch Experiments

| | Column Capacity | Batch Capacity |
|---|---|---|
| Adsorbent | (mg/g) | (mg/g) |
| LaCO₃ | 20.1 | 21.3 |
| CaCO₃ | 13.0 | 16.9 |
| MgCO₃ | 17.8 | 21.4 |

In a still further embodiment, an open celled foam may be coated or impregnated with iron to further facilitate the removal of phosphates as well as nitrates and ammonia. In an embodiment, foam is coated with ferric hydroxide. In a further embodiment, the foam (e.g. polyurethane foam or “PU” foam) is impregnated with iron.

Impregnated foam is created by adding the PU foam to FeCl₂ concentration of between 0.002 and 0.10 M and subjected to oxidation conditions for a total of 24 hours at 1° C., followed by washing with Q-H₂O and drying at 80° C. for 4 hours. The treatments resulted in the following iron impregnated samples. (i) PU-Fe-degas: Ferrous chloride was dissolved into the degassed water containing PU foam by shaking for 24 hours and the pH was adjusted to 4.2-4.5 followed by washing and drying; (ii) PU-Fe: The same as (i) but without degassing for oxygen removal; (iii) PU-Fe—O₂: during the mixing process, air was constantly bubbled through the system, the pH was adjusted to 5.0 with NaOH for the first 8 hours and a pH of 6.5 for the next 16 hours, prior to washing and drying; (iv) PU-Fe—H₂O₂: hydrogen peroxide was added four times during the mixing, with 6 hour intervals, according to the ratio of FeCl₂.4H₂O/H₂O₂) 10 g/20 ml each time and pH was controlled at 4.5-5.0; (v) PU-Fe—NaClO: sodium hypochlorite was added four times during the mixing, with 6 hour intervals, according to a ratio of FeCl2.4H2O/NaClO) 10 g/20 ml and pH was controlled at 4.5-5.0.

The performance of PU foam materials was assessed on the basis of both the amount of iron impregnated and the phosphate adsorption isotherm and pH edge. Iron in PU-Fe foam was extracted following the established acid extraction procedure (50): 0.100 g of sample was mixed with 30 mL of 1:1 HCl, followed by shaking (150 rpm) at 25 (1° C. for 2 h and then heating in a water bath at 90° C. for 20 min. The supernatant was collected by filtration and analyzed by ferrozine spectrophotometric method (51, 52). The ability of various PU foams samples for phosphate removal was assessed in batch systems using a sodium phosphate solution. In each test, 90.0 mg of the PU foam was weighed into 50-mL glass bottle, followed by addition of 30.00 mL Sodium phosphate solution, resulting in a solid loading of 3.00 g/L. After mixing on a shaker (150 rpm) for 24 hours at 1° C., the sample was filtered through a 0.45-μm membrane and the filtrate was analyzed for phosphate. The quantity of adsorbed phosphate was calculated by the difference between the initial and residual amounts of phosphate in solution divided by the weight of the adsorbent.

An adsorption isotherm was obtained by changing initial phosphate concentration from 0.10 to 30.0 mg/l at constant pH of 4.70 (acetate buffer). The adsorption edge was measured at 0.05-5.0 mg/l of total phosphate and the pH was adjusted by NaOH or HNO₃. The maximum amount of NaOH or HNO₃ added was 0.20 mmol, so the ionic strength of the system was from 0.100 to 0.107.

As illustrated in FIG. 6, the amount of iron impregnated onto PU (40 ppi) increased with increasing initial concentrations of Fe(II), tested with up to 0.10 M of FeCl₂. The test conducted in an anaerobic nitrogen environment (a) represented the amount of ferrous iron that could be impregnated into the PU foam, since significant ferrous iron oxidation was not expected. Other sets involved oxidation of ferrous iron by oxygen present in the ambient air (b), supplied by active aeration (c), by addition of H₂O₂ (d), or NaClO (e), during the impregnation process. Results showed that the amount of iron impregnated was the lowest when no oxidant was present. Slightly more, but similar, amounts of iron were impregnated when oxygen was present in the ambient air or provided by active aeration: 14.5 and 12.8 mg/g of iron were impregnated, respectively, when an initial Fe²⁺ concentration was 0.10 M. Addition of H₂O₂ at very low Fe²⁺ concentration did not enhance iron impregnation, but at higher concentrations (0.05 and 0.10 M) it doubled the amount impregnated when compared to oxygenation alone. Sodium hypochlorite (NaClO) was most effective, with the impregnated amount reaching 40 mg/g of PU foam at an initial iron concentration of 0.10 mol/L. Surface chemical differences and conditions influence the sorption capacity toward iron (57). Since Fe(III) in general has stronger complexation with ligands such as carboxyl and phenol groups than Fe(II), iron impregnation should be more effective when iron is present in trivalent oxidation state.

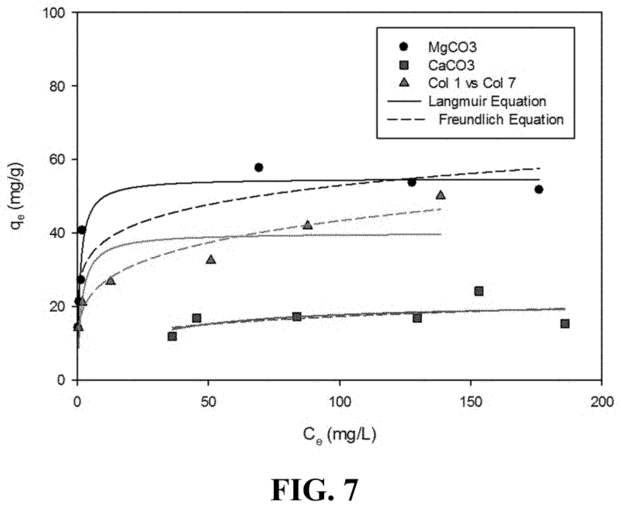

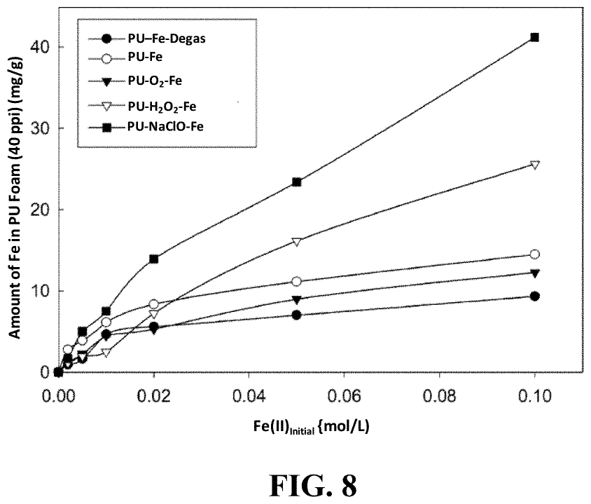

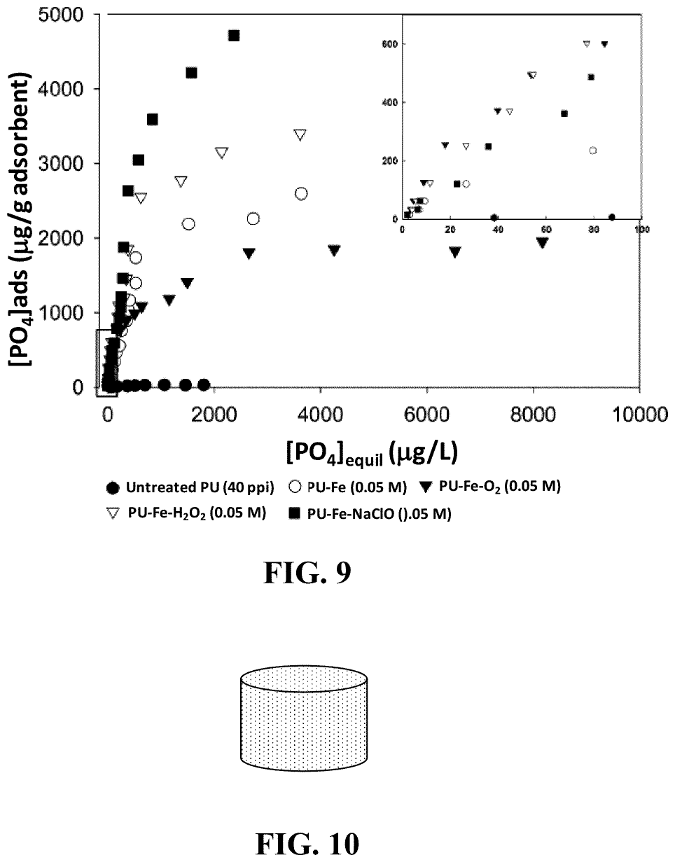

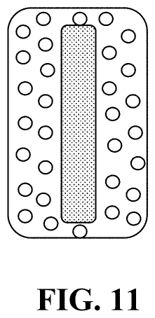

Removal of Phosphate: Batch tests on phosphate removal were conducted at two initial phosphate concentrations (105 and 1031 μg/L) for all treated PU foam samples under various initial concentrations of iron coupled with different oxidants. Because of the high adsorption capacity of the adsorbents, relatively high concentrations of phosphate had to be used to compare the relative effectiveness of different materials. Solid/solution ratio in the tests was 90.0 mg solid/30.0 mL solution. Solution pH was at 4.70, controlled by 0.010 M acetate buffer, and temperature was 25.0 (1° C.). The equilibration time was 24 h. Results (Table 3) indicated that phosphate removal reached 99.5% at phosphate concentration of 105 μg/L and 98.4% at phosphate concentration of 1031 μg/L. Phosphate adsorption isotherms were determined for untreated PU foam samples and treated Pu foam samples by 0.50 M Fe(II) (FIG. 7). Phosphate adsorption onto untreated PU foam was minimal; in comparison, all treated PU foam samples had much higher adsorption and the amount adsorbed was the highest for the one treated with NaClO. As expected, the adsorbed amount of phosphate increased with increasing equilibrium concentration of aqueous phosphate. The adsorption followed Langmuir equation:

$${q}_{e} = \frac{{q}_{max} C}{b + C}$$

where qe (μg phosphate/g adsorbent) was the amount of phosphate adsorbed and C was the equilibrium concentration of phosphate (μg/L) in the solution. qₘₐₓ and b are fitting parameters representing the maximum adsorption of phosphate and the adsorption constant, respectively. The parameters, obtained through nonlinear fit of the experimental data, are listed in Table 4. The maximum adsorption of arsenic was the highest for the sample prepared by NaClO oxidation, reaching 6572 μg phosphate/g of adsorbent with 2.34% of iron. Data analysis also showed that Freundlich adsorption model could not represent the adsorption data adequately.

What is claimed is:

1. An adsorbent for adsorbing phosphate from an aqueous medium comprising structures configured from at least one water insoluble carbonate.

2. The adsorbent of claim 1 further comprising a binder that can be removed from said structure to make said structure porous without damaging said structure and leaving a porous body as the binder is removed.

3. The adsorbent of claim 2, wherein said binder is removed by calcining said structure.

4. The adsorbent of claim 3, wherein said binder is cellulose.

5. The adsorbent of claim 4, wherein said structure is calcined at a temperature of at least 200° C. for 1 hour.

6. The adsorbent of claim 5, wherein said structure is a cylindrical pellet.

7. The adsorbent of claim 2, wherein an open cell foam structure is impregnated or coated with iron to facilitate phosphate, nitrate, and ammonia removal through one or more of coating iron onto the foam and impregnating the foam with iron.

8. A system for removing phosphates, nitrates, and ammonia from water comprising a porous housing to contain the adsorbent of claim 1 arranged within an open cell foam structure impregnated or coated with iron.

9. An adsorbent made by the process of:
a. creating a slurry pre-mix by mixing at least one carbonate with a binder;
b. creating a slurry by mixing said slurry pre-mix with deionized water;
c. drying said slurry into a concentrate;
d. grinding said concentrate into a powder;
e. compressing said powder into a desired structure; and
f. calcining said structure to remove said binder.

10. The adsorbent of claim 9, wherein the mass concentration of said binder in said slurry pre-mix is no more than 33%.

11. The adsorbent of claim 10, wherein the mass concentration of said binder in said slurry pre-mix is approximately 10%.

12. The adsorbent of claim 9, wherein said binder is cellulose.

13. The adsorbent of claim 10, wherein said slurry is calcined at a temperature of at least 250° C. until said binder in said slurry is removed.

14. The adsorbent of claim 13, wherein said slurry is calcined at a temperature of approximately 300° C. until said binder in said slurry is removed.
